(19) United States
(12) Patent Application Publication
(10) Pub. No.: US 2022/0128997 A1
(43) Pub. Date: Apr. 28, 2022

(54) SELF-PROPELLED DEVICE AND METHOD FOR CONTROLLING THE SAME

(71) Applicant: Hobot Technology Inc., Chupei City (TW)

(72) Inventors: Chung-Yuan HUANG, Chupei City (TW); Chui-Yao YANG, Chupei City (TW)

(21) Appl. No.: 17/402,138

(22) Filed: Aug. 13, 2021

(30) Foreign Application Priority Data
Oct. 23, 2020 (CN) 202011144888.8

(51) Int. Cl. G05D 1/02; G01C 21/00; G01C 21/20; G05D 1/00

(52) U.S. Cl. CPC G05D 1/0212; G01C 21/383; G05B 15/02; G05D 1/0044; G01C 21/206

(57) ABSTRACT

The present disclosure provides a self-propelled device and a method for controlling the same. The self-propelled device can perform an operation. The operation includes the step of: obtaining map data including a plurality of virtual gateways, in which each of the virtual gateways corresponds to a divided area and includes an open status or a closed status; receiving cleaning information from a remote device, in which the cleaning information includes virtual gateway control information, and the virtual gateway control information includes information that the virtual gateways are in the open status or the closed status; searching for a first divided area, which meets a predetermined condition, from currently enterable divided areas according to the virtual gateway control information; and allowing the self-propelled device to enter the first divided area and move throughout the first divided area. In this way, it is convenient for a user to operate the desired area to be cleaned.

### BACKGROUND OF THE INVENTION

### 1. Field of the Invention

The present disclosure relates to a self-propelled device and a method for controlling the self-propelled device, and in particular to a self-propelled device and a method for controlling the same that facilitates a user to control a divided area to be cleaned.

### 2. Description of the Related Art

Currently, it is known that a self-propelled device can move by itself around objects, obstacles, walls and surfaces in surrounding environment. In some cases, it may be necessary to restrict the self-propelled device to move within a specific area. To do this, a barrier can be set to prevent the self-propelled device from moving out of the specific area. For example, a marker can be detected by the self-propelled device, and a marking device can be placed in the environment to restrict the self-propelled device from entering and moving out from the specific area.

In addition, Self-propelled devices can also be used to move throughout surfaces and perform operations, such as cleaning, performing a surface treatment, and/or painting. However, in the conventional technologies, from a user's point of view, the movement path of the self-propelled device may be unpredictable, and thus the user cannot control the area that needs to be cleaned. In addition, there is no function which allows a user to input cleaning information in the conventional technologies. U.S. Pat. No. 10,168,709B2 discloses a technology that allows users to control the order of cleaning areas. However, the cleaning sequence made by the user may not be the best cleaning path, resulting in too much time needed for cleaning. In addition, the planning of the movement path of the self-propelled device is more complicated.

### BRIEF SUMMARY OF THE INVENTION

An objective of the present disclosure is to provide a self-propelled device, which can receive cleaning information from a remote device and clean an area allowed by a virtual gateway specified in the cleaning information.

According to an embodiment of the present disclosure, the self-propelled device includes a moving means, a sensing module and a control module. The moving means is used for moving the self-propelled device on a surface. The sensing module is used for sensing information of the self-propelled device moving on the surface. The control module is electrically connected to the sensing module and the self-propelled device. The control module includes a processor and a memory. The memory is coupled to the processor, and the memory includes a non-transitory computer-readable storage medium storing a computer-readable program code, wherein the computer-readable program code is executed by the processor to perform an operation. The operation includes: obtaining map data including a plurality of virtual gateways, in which each of the virtual gateways corresponds to a divided area and includes an open status or a closed status, wherein the open status is configured to allow the self-propelled device to pass through, and the closed status is configured to prevent the self-propelled device from passing through; receiving cleaning information from a remote device, in which the cleaning information includes virtual gateway control information, and the virtual gateway control information includes information that the virtual gateways are in the open status or the closed status; searching for a first divided area, which meets a predetermined condition, from currently enterable divided areas according to the virtual gateway control information; and allowing the self-propelled device to enter the first divided area and move throughout the first divided area.

In an embodiment, the virtual gateway control information includes an open status of a first part of the virtual gateways, so that the self-propelled device enters the divided areas corresponding to the first part of the virtual gateways.

In an embodiment, in the operation, the step of moving throughout the first divided area includes: after moving throughout the first divided area, obtaining a pattern of the first divided area and updating the map data.

In an embodiment, the step of moving throughout the first divided area in the operation includes: allowing the virtual gateway of the first divided area to be in the closed status after the self-propelled device enters the first divided area; and after moving throughout the first divided area, obtaining a pattern of the first divided area and updating the map data. The operation further includes: allowing the virtual gateway of the first divided area to be in the open status after the self-propelled device moves throughout the first divided area, and allowing the virtual gateway of the first divided area to be in the closed status after the self-propelled device leaves the first divided area; searching for, according to the virtual gateway control information, a second divided area that meets the predetermined condition from the currently enterable divided areas excluding the first divided area; allowing the self-propelled device to enter the second divided area and allowing the virtual gateway of the second divided area to be in the closed status, so that the self-propelled device moves throughout the second divided area; and obtaining a pattern of the second divided area and updating the map data after the self-propelled device moves throughout the second divided area.

In an embodiment, the predetermined condition includes: among multiple paths between the self-propelled device and the currently enterable divided areas, a path between the self-propelled device and the first divided area is the shortest; or among multiple paths between the self-propelled device and the virtual gateways of the currently enterable divided areas, a path between the self-propelled device and the virtual gateway of the first divided area is the shortest.

In an embodiment, the step of obtaining the map data in the operation includes: generating the map data based on the information of the self-propelled device moving on the surface, in which the map data include the divided areas, and the divided areas correspond to multiple areas of the surface, respectively; and arranging the virtual gateways on the divided areas, respectively.

In an embodiment, the virtual gateway control information is formed by a user selecting at least a part of a plurality of divided area images of the divided areas of the map data displayed on the remote device.

In an embodiment, each of the at least a part of the divided area images further includes a virtual gateway image, and the virtual gateway control information is formed by the user selecting at least a part of the virtual gateway images displayed on the remote device.

In an embodiment, each of the at least a part of the divided area images further includes a virtual gateway image, and the virtual gateway control information is formed by the user selecting at least a part of the virtual gateway images displayed on the remote device.

In an embodiment, the cleaning information further includes a cleaning mode of at least one of the divided areas, and the cleaning mode is formed by selecting cleaning mode options of the at least one of the divided areas from a setting window displayed, on the remote device, after the user selects the divided area images of the map data displayed on the remote device.

According to an embodiment of the present disclosure, a method for controlling a self-propelled device is provided, wherein the self-propelled device comprises a moving means for moving the self-propelled device on a surface; a sensing module for sensing information of the self-propelled device moving on the surface; and a control module electrically connected to the sensing module and the self-propelled device. The method comprises: obtaining map data including a plurality of virtual gateways, in which each of the virtual gateways corresponds to a divided area and includes an open status or a closed status, wherein the open status is configured to allow the self-propelled device to pass through, and the closed status is configured to prevent the self-propelled device from passing through; receiving cleaning information from a remote device, in which the cleaning information includes virtual gateway control information, and the virtual gateway control information includes information that the virtual gateways are in the open status or the closed status; searching for a first divided area, which meets a predetermined condition, from currently enterable divided areas according to the virtual gateway control information; and allowing the self-propelled device to enter the first divided area and move throughout the first divided area.

In an embodiment, the step of moving throughout the first divided area further includes: allowing the virtual gateway of the first divided area to be in the closed status after the self-propelled device enters the first divided area; and obtaining a pattern of the first divided area and updating the map data after the self-propelled device moves throughout the first divided area. The operation method further includes: allowing the virtual gateway of the first divided area to be in the open status after the self-propelled device moves throughout the first divided area, and allowing the virtual gateway of the first divided area to be in the closed status after the self-propelled device leaves the first divided area; searching for, according to the virtual gateway control information, a second divided area that meets the predetermined condition from the currently enterable divided areas excluding the first divided area; allowing the self-propelled device to enter the second divided area and allowing the virtual gateway of the second divided area to be in the closed status, so that the self-propelled device moves throughout the second divided area; and obtaining a pattern of the second divided area and updating the map data after the self-propelled device moves throughout the second divided area.

In an embodiment, the predetermined condition includes: among multiple paths between the self-propelled device and the currently enterable divided areas, a path between the self-propelled device and the first divided area is the shortest; or among multiple paths between the self-propelled device and the virtual gateways of the currently enterable divided areas, a path between the self-propelled device and the virtual gateway of the first divided area is the shortest.

In an embodiment, the step of obtaining the map data includes: generating the map data based on the information of the self-propelled device 200 moving on the surface, in which the map data include the divided areas, and the divided areas correspond to multiple areas of the surface, respectively; and arranging the virtual gateways on the divided areas, respectively.

In an embodiment, before receiving the cleaning information from the remote device, the method further includes: generating the cleaning information by using the remote device.

In an embodiment, the step of generating the cleaning information by using the remote device includes: showing, by the remote device, a plurality of divided area images of the divided areas of the map data; and generating the virtual gateway control information according to a signal of at least a part of the divided area images displayed on the remote device and selected by a user.

In an embodiment, each of the at least a part of the divided area images further includes a virtual gateway image, and the virtual gateway control information is formed by the user selecting at least a part of the virtual gateway images displayed on the remote device.

In an embodiment, the cleaning information further includes a cleaning mode of at least one of the divided areas, and the cleaning mode is formed by selecting cleaning mode options of the at least one of the divided areas from a setting window displayed, on the remote device, after the user selects the divided area images of the map data displayed on the remote device.

In an embodiment, the step of generating the cleaning information by using the remote device includes: showing, by the remote device, a plurality of divided area images of the divided areas of the map data; generating the virtual gateway control information according to a signal of at least a part of the divided area images displayed on the remote device and selected by a user; and after the user selects the divided area images displayed on the remote device, showing a setting window by the remote device, and generating the cleaning information according to the cleaning mode of the divided areas selected by the user.

In summary, it is an object of an embodiment of the present disclosure to provide a self-propelled device, which can receive a cleaning information from remote device, and clean the area allowed by the virtual gateway specified in the cleaning information for the self-propelled device to pass through. In this way, it is convenient for a user to operate the area to be cleaned. In addition, in an embodiment, the remote device does not need to include complete map data, and only the data of multiple virtual gateways on the surface are required. Preferably, in an embodiment, after cleaning the divided area corresponding to the virtual gateway that can be passed through, the map data of the divided area can be obtained and then the map data can be updated to obtain complete map data.

### BRIEF DESCRIPTION OF THE DRAWINGS

FIG. 1A is a top view illustrating self-propelled device according an embodiment of the present disclosure.

FIG. 1B is a functional block diagram of a self-propelled device according to an embodiment of the present disclosure.

FIG. 1C shows a connection among a self-propelled device, a remote device, and a server according to an embodiment of the present disclosure.

FIG. 2 shows map data displayed on the remote device according to an embodiment of the present disclosure.

FIG. 3 is a flowchart showing a method for controlling a self-propelled device according to an embodiment of the present disclosure.

FIG. 4A shows map data displayed on the remote device according to an embodiment of the present disclosure.

FIG. 4B shows map data displayed on the remote device according to another embodiment of the present disclosure.

FIG. 4C shows map data displayed on the remote device according to another embodiment of the present disclosure.

FIG. 4D shows map data displayed on the remote device according to another embodiment of the present disclosure.

FIG. 5A is a schematic diagram showing an algorithm for the shortest distance according to an embodiment of the present disclosure.

FIG. 5B shows a schematic diagram of an algorithm for the shortest distance according to an embodiment of the present disclosure.

### DETAILED DESCRIPTION OF THE INVENTION

The present disclosure will be explained in detail with reference to the accompanying drawings, in which the same reference numerals will be used to identify the same or similar elements under multiple viewpoints. It should be noted that the drawings should be viewed in the orientation direction of the label.

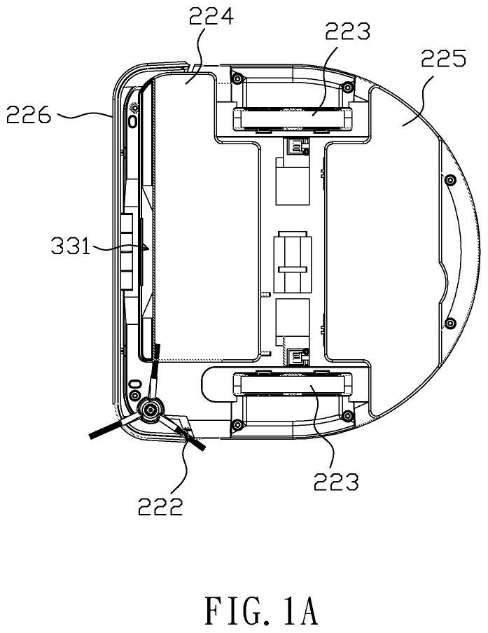

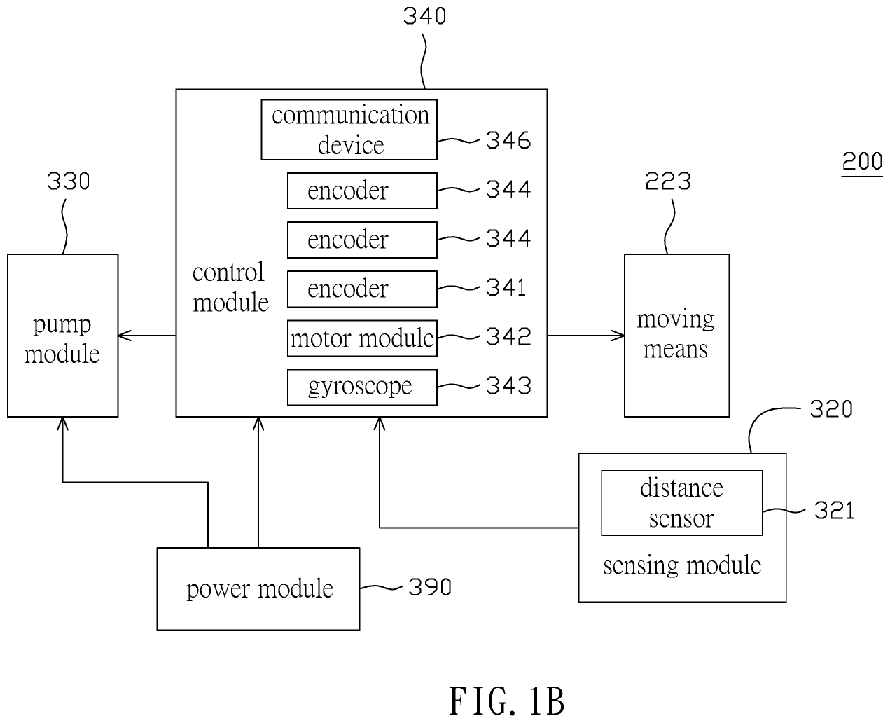

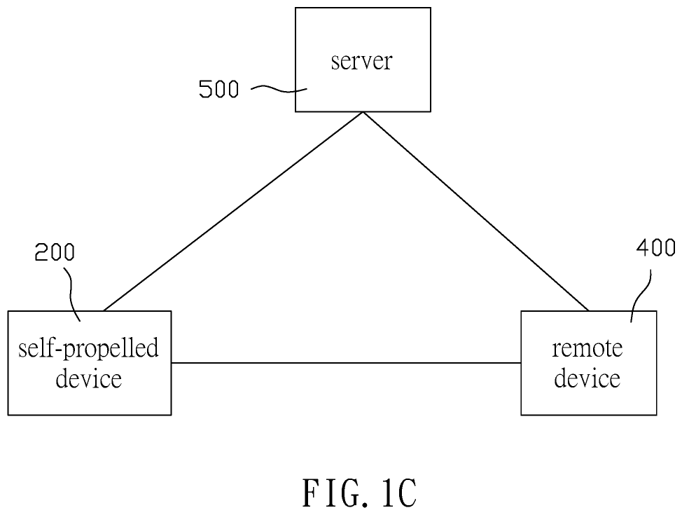

According to an embodiment of the present disclosure, a self-propelled device and a method for controlling a self-propelled device are provided. The self-propelled device can be a cleaning device or a cleaning robot. FIG. 1A is a top view illustrating a self-propelled device according to an embodiment of the present disclosure. As shown in FIG. 1A, the self-propelled device 200 includes a suction inlet 331, at least one side brush 222, a moving means 223 and a cleaning means 224, 225. The side brush 222 extends downward to sweep dust on the ground into the suction inlet 331. The cleaning means 224,225 can include a cleaning cloth disposed on the bottom side and facing downwards for wiping the ground. In an embodiment, the moving means 223 can be a pulley configuration having two wheels and a belt connected between the wheels. In an embodiment, an anti-collision bar 226 is disposed in front of the self-propelled device 200 for sensing an event of colliding with an obstacle.

FIG. 1B is a functional block diagram illustrating the self-propelled device according to an embodiment of the present disclosure. Referring to FIG. 1B, in this embodiment, the self-propelled device 200 further includes a sensing module 320, a pump module 330, a control module 340 and a power module 390. The power module 390 is used for providing power to the pump module 330 and the control module 340. The pump module 330 drives a vacuum cleaning means (not shown) to perform vacuum cleaning, sucks dust from the suction inlet 331, and collects the dust in a dust collecting belt (not shown). The sensing module 320 includes at least one distance sensor 321.

The distance sensor 321 is electrically connected to the control module 340 for transmitting distance data to the control module 340. The control module 340 includes an encoder 341, a motor module 342, a gyroscope 343, a processor (CPU) 344 and a memory 345. The motor module 342 drives the moving means 223 to move the self-propelled device 200 back and forth or turn the self-propelled device 200 left and right. The motor module 342 is electrically connected to the encoder 341. A moving distance or a turning angle is obtained by the encoder 341 according to an operating signal of the motor module 342. The distance traveled by the self-propelled device 200 or the turning angle of the self-propelled device 200 can be calculated from the reading value of the encoder 341. The gyroscope 343 of the control module 340 is used for measuring the angular velocity (ω) of the self-propelled device 200, and the angular velocity (ω) is integrated to obtain the integral angle (iA) of the device. The encoder 341 performs inertial navigation according to at least one of the moving distance, the turning angle and the integral angle (iA), and zigzags back and forth for cleaning.

In an embodiment, the control module 340 can further include a communication device 346. The communication device 346 can be a wireless communication device or a wired communication device. Preferably, the communication device 346 is a wireless communication device for communicating with a remote device, receiving information from a remote device, or transmitting information to the remote device. The wireless communication can be short-distance point-to-point communication, wireless sensor network, wireless network and other technologies. The short-distance point-to-point communication can be, for example, radio frequency identification (RFID), transfer jet, wireless universal serial bus, dedicated short range communications (DSRC), EnOcean, and near field communication. The wireless sensor network can be, for example, ZigBee, EnOcean, wireless personal network, Bluetooth, ultra-wideband (UWB), etc. The wireless network can be, for example, a wireless local area network (WLAN, such as Wi-Fi and HiperLAN, etc.), global interoperability for microwave access (WiMAX), and the like.

In an embodiment, the rotary encoder 341 that detects the rotation speed of the wheels of the moving means 223 can be disposed on the motor module 342 of the moving means 223. The control module 340 may be further provided with a front or side proximity sensor (distance sensor 321) for detecting front or side obstacles. The signal sent from the sensor is, for example, an infrared beam. The infrared beam generates reflected light when it collides with an object. The control module 340 detects the reflected light and calculates the distance between the sensor and the obstacle. In order to reliably detect obstacles and wall surfaces, the side proximity sensor is disposed on the right or left side of the self-propelled device 200. In this embodiment, the right side of the self-propelled device 200 moves along the wall, and the side proximity sensor is disposed at a position which makes the side proximity sensor is capable of sensing the right side of the self-propelled device 200.

The control module 340 drives the motor module 342 to move the self-propelled device 200 according to the information detected by the rotary encoder 341, the gyroscope 343, the front proximity sensor and the side proximity sensor (distance sensor 321). The control module 340 is a computer system equipped with a CPU, a memory, and an input/output circuit. In order to perform the operation of the self-propelled device 200, a computer program is stored in the memory 345. The memory 345 is coupled to the processor 344, and the memory 345 includes a non-transitory computer-readable storage medium storing a computer-readable program code that can be executed by the processor 344 to perform an operation. A part of the memory 345 of the control module 340 is used for storing map information 361.

FIG. 1C shows the connection among a self-propelled device, a remote device and a server according to an embodiment of the present disclosure. As shown in FIG. C, in an embodiment, the self-propelled device 200 communicates with the server 500 through an Internet network, and then transmits the map data 690 to the server 500. Further, the remote device 400 also communicates with the server 500 through the Internet, and downloads the map data 690 from the server 500. Preferably, the remote device 400 may be a device with display and calculation functions, and it may be a mobile device. Preferably, the mobile device may have a display screen, touch input, or a small keyboard. For example, the mobile device can be a mobile phone, a notebook computer, a tablet computer, a point-of-sale information machine (POS machine), a personal digital assistant (PDA), an on-board computer, a smart phone, etc.

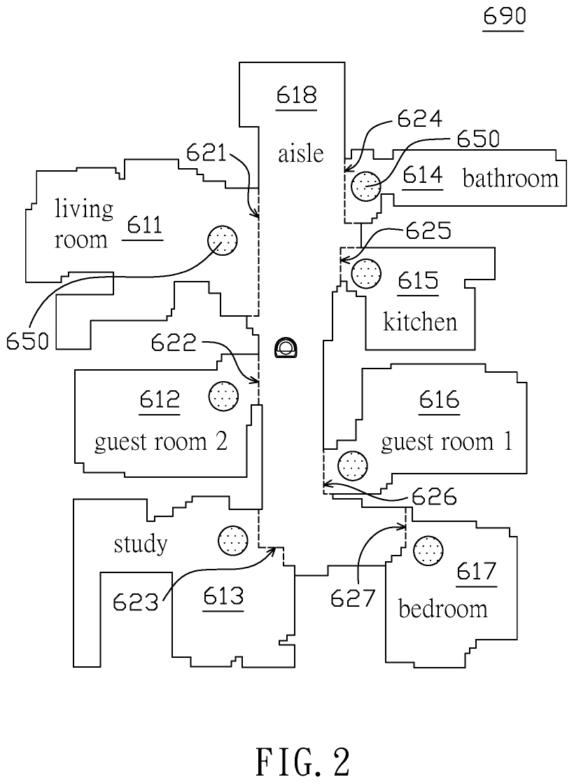

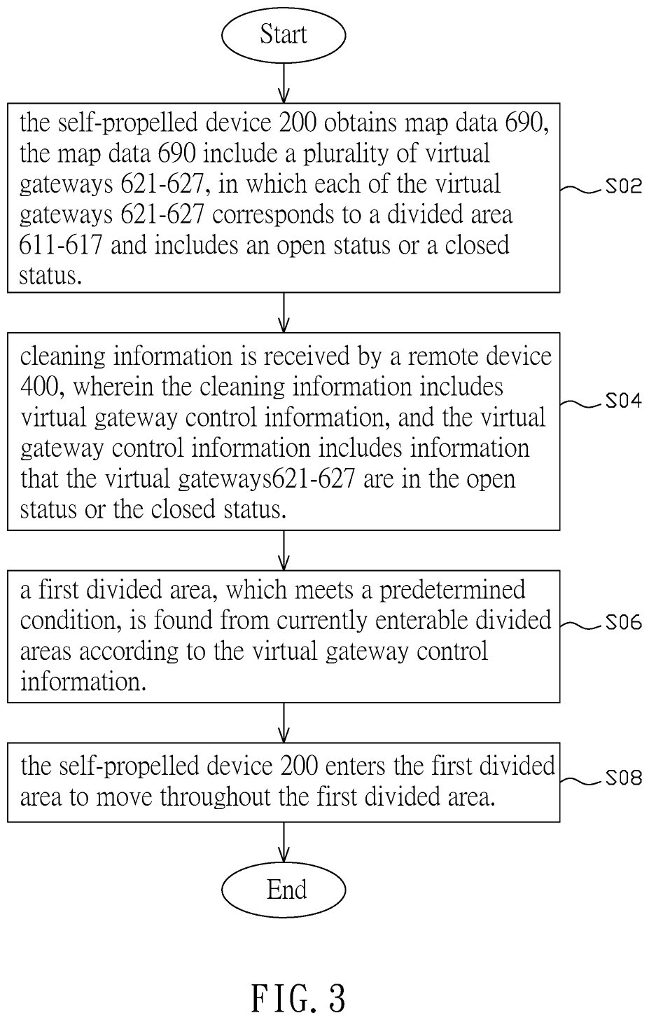

FIG. 2 shows map data displayed on the remote device according to an embodiment of the present disclosure. FIG. 3 is a flowchart showing a method for controlling a self-propelled device according to an embodiment of the present disclosure. Referring to FIG. 2 and FIG. 3, the method for controlling a self-propelled device according to an embodiment of the present disclosure includes the following steps.

Step S02: the self-propelled device 200 obtains map data 690, the map data 690 include a plurality of virtual gateways 621-627, in which each of the virtual gateways 621-627 corresponds to a divided area 611-617 and includes an open status or a closed status, wherein the open status is configured to allow the self-propelled device 200 to pass through, and the closed status is configured to prevent the self-propelled device 200 from passing through. In an embodiment, the step S02 includes: generating the map data 690 based on the information of the self-propelled device 200 moving on the surface (Step S22); and arranging the virtual gateways 621-627 on the divided areas 611-617, respectively (Step S24). More specifically, the self-propelled device 200 moves on a surface, and the sensing module 320 is used to sense information of the environment to generate map data 690. In an embodiment, after the self-propelled device 200 moves throughout the whole surface, the sensing module 320 is used for measuring environmental data during moving to generate map data 690, as shown in FIG. 2, and the map data 690 include multiple divided areas 611-617 corresponding to multiple areas of the surface. Then, the divided areas 611-617 are analyzed to obtain the parts which can be passed through, and the virtual gateways 621-627 are correspondingly arranged on the divided areas 611-617.

Please note that according to an embodiment of the present disclosure, the map data 690 only needs to be information of at least a part of the virtual gateways 621-627, and there is no limitation to the method of obtaining the map data. Preferably, the map data 690 only need to include the position information on the surface of the virtual gateways 621-627. In an embodiment, the map data 690 can be obtained from the server 500 or the remote device 400 by the self-propelled device 200, and is not obtained by the measurement of the sensing module 320.

Step S04: cleaning information is received by a remote device 400, wherein the cleaning information includes virtual gateway control information, and the virtual gateway control information includes information that the virtual gateways 621-627 are in the open status or the closed status. The user can select the areas which need to be cleaned from the patterns in FIG. 2, and then set the virtual gateways of the areas which need to be cleaned (that is, the first part of the virtual gateways) to be in the open status, such that the self-propelled device 200 can enter the divided areas corresponding to the first part of the virtual gateways.

Step S06: a first divided area, which meets a predetermined condition, is found from currently enterable divided areas according to the virtual gateway control information. In an embodiment, the self-propelled device 200 finds the closest divided area from the currently enterable divided areas. For example, the user selects the divided area 612, the divided area 613 and the divided area 617 as the part to be cleaned (for example, the first part). As shown in FIG. 2, since the divided area 612 (which can be the first divided area) is closest to the self-propelled device 200, the self-propelled device 200 cleans the divided area 612 first. In order to reduce the number of calculations, the subsequent cleaning order can be determined at this time. For example, in comparison with the divided area 617, since the self-propelled device 200 is closer to the divided area 613, the subsequent cleaning order is the divided area 613 and the divided area 617, respectively. In an embodiment, multiple calculations can be performed to determine the subsequent cleaning sequence. That is, after the self-propelled device 200 cleans the divided area 612, it is calculated again and measured that the divided area 613 is closer to the divided area 612. Therefore, the divided area 613 is cleaned first. After the self-propelled device 200 cleans the divided area 613, the divided area 617 closest to the divided area 613 is determined as the next area to be cleaned.

Step S08: the self-propelled device 200 enters the first divided area to move throughout the first divided area. In an embodiment, as in the aforementioned step S06, after the self-propelled device 200 enters the divided area 612, the virtual gateway 622 of the divided area 612 is in the closed status. In an embodiment, preferably, after the self-propelled device moves throughout the divided area 612, the pattern of the divided area 612 is obtained, and the map data 690 are updated.

In an embodiment, the method for controlling a self-propelled device can further include the step S03 of generating cleaning information by using the remote device 400. Preferably, the step S03 is performed before the step S04.

According to the foregoing embodiment, the self-propelled device moves throughout the divided area 612 and then enters the divided area 613, so as to clean the divided area 613. The process can include the following steps.

Step S12: after the self-propelled device 200 moves throughout the divided area 612, the virtual gateway 622 of the divided area 612 is allowed to be in the open status, and after the self-propelled device 200 leaves the divided area 612, the virtual gateway 622 of the divided area 612 is allowed to be in the closed status.

Step S14: according to the virtual gateway control information, the divided area 613 which meets the predetermined condition is found from the currently enterable divided areas excluding the cleaned divided area 612, i.e., from the divided area 613 and the divided area 617. As described in the foregoing step S06, the cleaning sequence may be determined before cleaning the divided area 612, or may be determined by performing calculation again after cleaning the divided area 612.

Step S15: the self-propelled device 200 enters the divided area 613, and the virtual gateway 623 of the divided area 613 is allowed to be in the closed status, such that the self-propelled device 200 moves throughout the divided area 613. Further, the previous steps appropriately repeated until all the selected divided areas are cleaned.

### <Generation of Map Data 690>

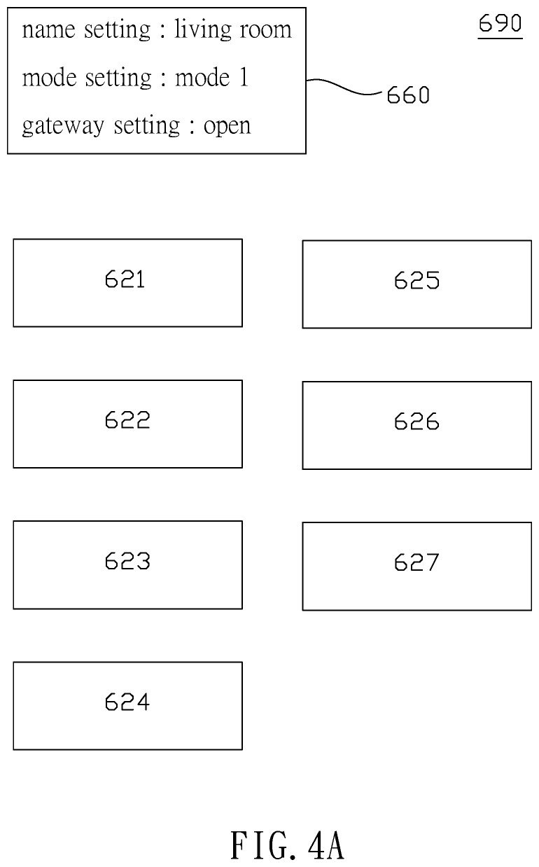

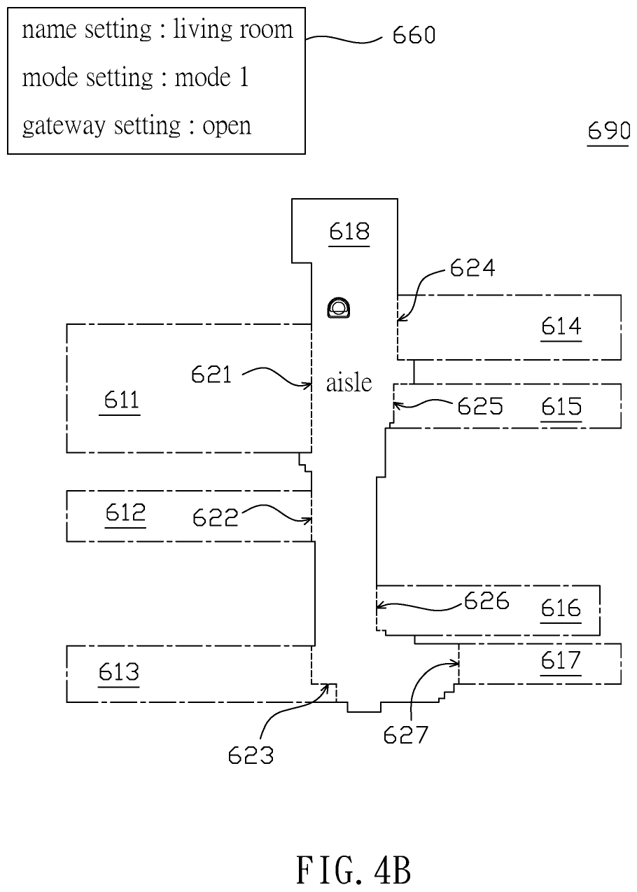

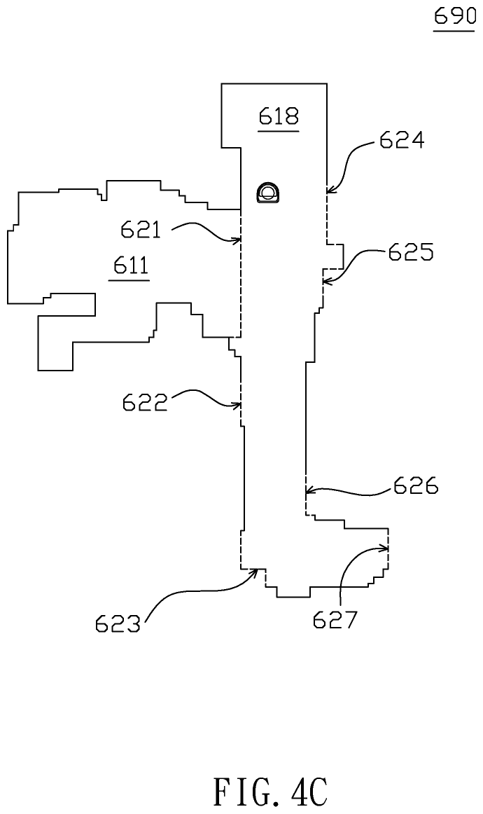

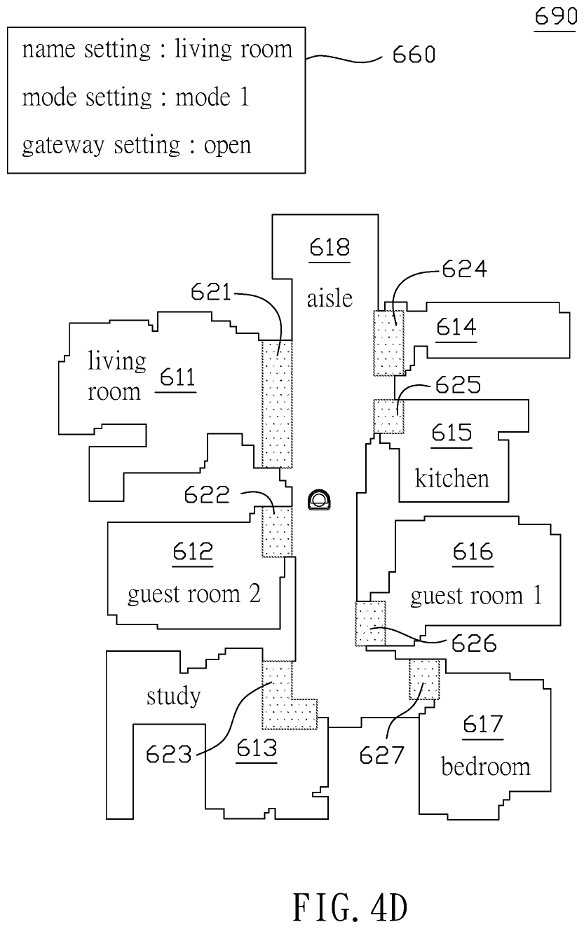

The present disclosure does not limit the method for generating the map data 690. In an embodiment, the user can take a photo of the divided area 618, use software analysis to obtain the map data 690 containing the position information of the virtual gateways 621-627, and then transmit the map data 690 to the self-propelled device 200. In an embodiment, the user can use the moving means to edit the map data 690 and then transmit the map data 690 to the self-propelled device 200. FIG. 4A shows map data displayed on the remote device according to an embodiment of the present disclosure. As shown in FIG. 4A, the user can use the remote device 400 to add virtual gateways 621-627, and edit the absolute or approximate positions of the virtual gateways 621-627 or the relative position between the virtual gateways 621-627 to generate map data 690. In an embodiment, after receiving the map data 690, the self-propelled device 200 can correct the map data 690 from the remote device 400 according to the map data measured by the sensing module 320. Therefore, the user does not need to input the precise positions of the virtual gateways, which increases the convenience of operation.

FIG. 4B shows map data displayed on the remote device according to another embodiment of the present disclosure. As shown in FIG. 4B, in an embodiment, the self-propelled device 200 may only move throughout the divided area 618 as a walkway to obtain the map data 690, and set virtual gateways 621-627 on the non-continuous and passable part of the wall. Preferably, predetermined patterns of the divided areas 611-617 can be displayed on the display panel of the remote device 400. The predetermined pattern is not an actual map, only for the user to recognize. For example, FIG. 4B shows the predetermined pattern of the divided areas 611-617 by forming a square with chain lines. However, the predetermined pattern can be any shape, such as a circle or a polygon, and there is no particular limitation.

FIG. 4C shows map data displayed on the remote device according to another embodiment of the present disclosure. In an embodiment, after moving throughout the divided area 611, the self-propelled device 200 obtains the pattern of the divided area 611 and updates the map data 690. In this embodiment, it is not necessary to move throughout the entire surface to obtain the map data 690. In this way, the data amount of the map data 690 is small to reduce the burden of network bandwidth, and the production time of the map data 690 is shorter, so that the user can obtain the map data 690 faster.

### <Algorithm for Predetermined Conditions>

The present disclosure does not limit the algorithm for the predetermined conditions, and preferably the one with the shortest distance can be used as the predetermined condition. Further, the shortest distance can be obtained by various algorithms. For example, in an embodiment, the predetermined condition may be that the path between the self-propelled device 200 and the first divided area is the shortest among the multiple paths between the self-propelled device 200 and the currently enterable divided areas.

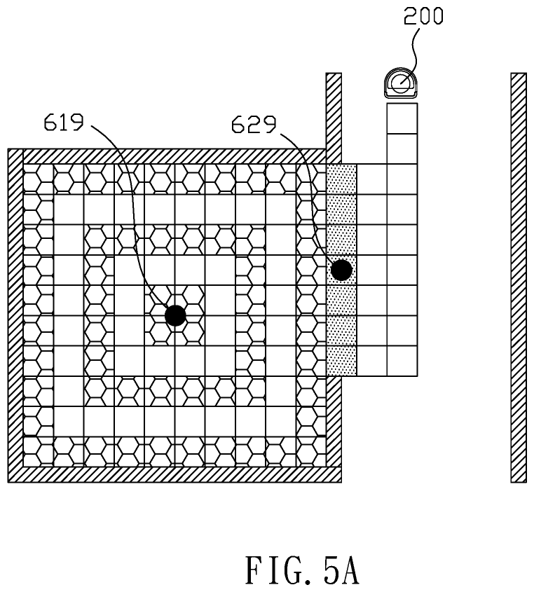

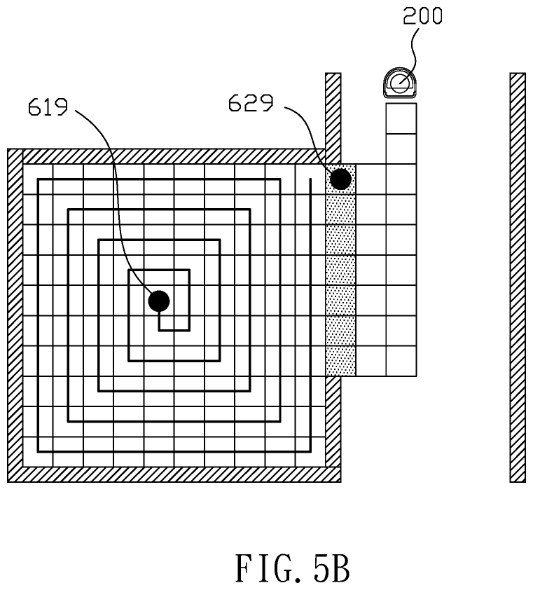

Various calculation methods can be used for the path between the self-propelled device 200 and the divided area, and are not limited by the present disclosure. Hereinafter, a foaming method is provided as an example. FIG. 5A is a schematic diagram showing an algorithm for the shortest distance according to an embodiment of the present disclosure. For the clarity, the figure only schematically fills in part of the grid. As shown in FIG. 5A, multiple grids are formed in the divided area, the grids of each layer from the wall to the inside of the room are gradually filled, and the center of the innermost grid position is found as the center coordinate 619 of the divided area. Then, the distance between the self-propelled device 200 and the center coordinate 619 of the divided area is calculated, or the number of grids between the self-propelled device 200 and the center coordinate 619 of the divided area is calculated. FIG. 5B shows a schematic diagram of an algorithm for the shortest distance according to an embodiment of the present disclosure. As shown in FIG. 5B, which is similar to FIG. 5A, the grids of each layer are gradually filled except that any grid is took as the starting point and the grid is spirally filled so as to obtain the last filled grid as the center coordinate of the divided area.

In an embodiment, the predetermined condition may be that the path between the self-propelled device 200 and the virtual gateway of the first divided area is the shortest among the multiple paths between the self-propelled device 200 and the virtual gateways of the currently enterable divided areas. Various calculation methods can be used for deciding the path between the self-propelled device 200 and the virtual gateway of the divided area, which is not limited by the present disclosure. Any point on the virtual gateway can be used as the coordinate. In an embodiment, as shown in FIG. 5A, the midpoint of the virtual gateway can be used as the coordinate 629 of the virtual gateway. In an embodiment, as shown in FIG. 5B, an end point of the virtual gateway can be used as the coordinate 629 of the virtual gateway. Then, the distance between the self-propelled device 200 and the coordinate 629 of the virtual gateway is calculated, or the number of grids between the self-propelled device 200 and the coordinate 629 of the virtual gateway is calculated.

In an embodiment, the self-propelled device 200 generates the map data 690 including divided areas, and transmits the map data 690 to the remote device 400. In an embodiment, as shown in FIG. 1B, the remote device 400 includes a communication device 346, and the communication device 346 may be a wireless communication device. In an embodiment, the remote device 400 communicates with the self-propelled device 200 through the communication device 346. In an embodiment, the communication device 346 communicates with the server 500, and the server 500 is configured to persistently store map data 690 containing grid information, divided areas, modified or updated divided areas, virtual gateways, or a combination thereof. In an embodiment, the remote device 400 transmits or receives the map data 6990 through the server 500. In an embodiment, the remote device 400 directly communicates with the self-propelled device 200 for receiving or transmitting map data 690, and preferably, can transmit the map data 690 to the server 500 through the remote device 400. In this way, the historical data corresponding to the self-propelled device 200 can be saved, maintained and/or analyzed.

In an embodiment, the user can use the remote device 400 to modify the divided areas in the map data 690. In an embodiment, the user can use the remote device 400 to set the divided areas to be cleaned and the divided areas which are not to be cleaned. In an embodiment, the self-propelled device 200 can be a self-moving floor cleaning robot. In an embodiment, the divided area in the map data 690 is generated by the self-propelled device 200 moving on the surface based on the data collected during cleaning. In an embodiment, the divided area can be generated by the edition of the remote device 400. In an embodiment, the remote device 400 may receive raw data corresponding to the surface of the enclosed space from the self-propelled device 200, and may use the raw data to generate the divided area.

In an embodiment, the image of the divided area can be displayed on the display of the remote device 400. The remote device 400 can be a mobile device, the mobile device can be a palm-type mobile terminal, and the display is a touch screen display. In an embodiment, a graphical user interface can be generated and displayed via a touch screen, and the touch screen can be used to receive input information from the user via the graphical user interface. In an embodiment, the remote device 400 can also be a monitor, a tablet computer, a computer including a screen and a mouse or touch interface, or a smart phone.

In an embodiment, the input information of the user can include cleaning information. For example, the cleaning information includes divided areas set with different cleaning modes and virtual gateway control information. In an embodiment, the input information of the user can include one or more cleaning task instructions for the enclosed space. For example, the cleaning task instruction can include a cleaning mode that identifies the area to be cleaned. In an embodiment, the cleaning task instruction can include instructions to be executed on certain days of the week or certain times of a day. In an embodiment, the cleaning task instruction includes cleaning modes corresponding to different cleaning levels of different areas, and the different cleaning levels can be achieved by specifying the number of times the self-propelled device 200 must move throughout the corresponding area.

### <Generation of Cleaning Information>

In an embodiment, Step S03: the remote device 400 displays multiple divided area images of the divided areas 611-617 of the map data 690 (step S32); and the virtual gateway control information of the cleaning information is generated according to a signal generated from the selection, by a user, of at least a part of the divided area images displayed on the remote device 400 (step S34).

FIG. 2 shows map data displayed on the remote device according to an embodiment of the present disclosure. As shown in FIG. 2, the map data 690 displayed by the remote device 400 includes multiple virtual gateways 621-627. The user can select at least a part of the divided area images displayed by the remote device 400 to respectively set the virtual gateways 621-627 to be in the open status or the closed status. The position, size or shape of the at least a part of the divided area images is not limited in the present disclosure. In order to allow the user to clearly recognize the position to be selected, a recognition pattern 650 can be formed on each of the divided area images. The recognition pattern 650 in FIG. 2 is circular, and the color or gray scale of the recognition pattern 650 is different from the color or gray scale of the corresponding virtual gateways 621-627, which is convenient for the user to recognize.

FIG. 4D shows map data displayed on the remote device according to another embodiment of the present disclosure. FIG. 4D shows a display graphic of the user interface of the remote device 400, which is used to allow the user to perform area labeling operations on the divided areas. In an embodiment, as shown in FIG. 4D, a pattern of virtual gateways 621-627 can be formed on each divided area image as the aforementioned at least a part of the divided area images. The patterns of the virtual gateways 621-627 can be formed into an appropriate size for the user to recognize and select conveniently. As shown in FIG. 4D, after the user selects the divided area images displayed on the remote device 400, a setting window appears. The setting window includes various options for the user to set cleaning information.

In an embodiment, the user selects the divided areas 611-617 to start the setting operation. As shown in FIG. 4A and FIG. 4D, the patterns of the virtual gateways 621-627 can be selected. As shown in FIG. 4B, any part of the divided areas 611-617 can be selected. As shown in FIG. 4A, FIG. 4B and FIG. 4D, after the user selects at least a part of the divided areas 611-617, the text box of the setting window 660 can be displayed, in which the text box includes the name setting. For example, in this embodiment, the user can input “living room” as the name of the area. In addition, the user can set the gateway to be in the open status, and set the cleaning mode as “mode 1”. In an embodiment, the cleaning mode includes various cleaning parameters, and each cleaning mode include different cleaning parameter, such as moving speed, water spray volume, vibration speed of wiping, number of times which the self-propelled device moves throughout the area, etc.

In an embodiment, according to the virtual gateway control information, a second divided area which meets the predetermined condition can be found from the currently enterable divided areas excluding the first divided area. Please note that the step of searching for a second divided area can be performed when the self-propelled device 200 is still in the first divided area, or can be performed after the self-propelled device 200 leaves the first divided area. In addition, the step of searching for a second divided area can be performed when the virtual gateway of the first divided area is in the open status, or can be performed when the virtual gateway of the first divided area is in the closed status. This can be set appropriately according to product specifications.

In an embodiment, the memory of the remote device 400 does not need to store complete map data, and only the data of multiple virtual gateways on the surface are required. For example, as shown in FIG. 2, the self-propelled device 200 can measure the virtual gateways 621-627 after moving throughout the divided area 618 that is a walkway. At this time, the map data 690 only include the map data of the divided area 618. The remote device 400 receives the information of the virtual gateways 621-627 from the self-propelled device 200 so that the user can select (a first part of) the virtual gateways 621-627 to be cleaned from the virtual gateways 621-627. In an embodiment, preferably, the self-propelled device 200 may, after cleaning the divided area corresponding to the virtual gateway which the self-propelled device 200 can pass through, obtain the map data of the divided area, and then update the map data. In this way, complete map data are obtained. For example, when the virtual gateway 621 is in the open status, the divided area 611 or the virtual gateway 621 is the closest to the self-propelled device 200, such that the self-propelled device 200 can enter the divided area 611 through the virtual gateway 621, and after moving throughout the divided area 611, the map data of the divided area 611 can be obtained, and the self-propelled device 200 can update the map data 690 at this time.

In summary, it is an object in an embodiment of the present disclosure to provide a self-propelled device, which can receive cleaning information from a remote device, and clean an area into which self-propelled device can enter due to the permission of a virtual gateway specified in the cleaning information. In this way, it is convenient for a user to operate the desired area to be cleaned. In addition, in an embodiment, the remote device does not need to include complete map data, and only the data of multiple virtual gateways on the surface are required. Preferably, in an embodiment, after cleaning the divided area corresponding to the virtual gateway that can be passed through, the map data of the divided area can be obtained and then the map data can be updated to obtain complete map data.

What is claimed is:

1. A self-propelled device, comprising:
a moving means for moving the self-propelled device on a surface;
a sensing module for sensing information of the self-propelled device moving on the surface; and
a control module electrically connected to the sensing module and the self-propelled device,
wherein the control module further comprises:
a processor; and
a memory, coupled to the processor and including: a non-transitory computer-readable storage medium storing a computer-readable program code, wherein the computer-readable program code is executed by the processor to perform an operation,
wherein the operation comprises:
obtaining map data including a plurality of virtual gateways, in which each of the virtual gateways corresponds to a divided area and includes an open status or a closed status, wherein the open status is configured to allow the self-propelled device to pass through, and the closed status is configured to prevent the self-propelled device from passing through;
receiving cleaning information from a remote device, in which the cleaning information includes virtual gateway control information, and the virtual gateway control information includes information that the virtual gateways are in the open status or the closed status;
searching for a first divided area, which meets a predetermined condition, from currently enterable divided areas according to the virtual gateway control information; and
allowing the self-propelled device to enter the first divided area and move throughout the first divided area.

2. The self-propelled device according to claim 1, wherein the virtual gateway control information includes an open status of a first part of the virtual gateways, so that the self-propelled device enters the divided areas corresponding to the first part of the virtual gateways.

3. The self-propelled device according to claim 1, wherein in the operation, the step of moving throughout the first divided area includes:
after moving throughout the first divided area, obtaining a pattern of the first divided area and updating the map data.

4. The self-propelled device according to claim 3, wherein
the step of moving throughout the first divided area further includes:
allowing the virtual gateway of the first divided area to be in the closed status after the self-propelled device enters the first divided area, and
the operation further includes:
allowing the virtual gateway of the first divided area to be in the open status after the self-propelled device moves throughout the first divided area, and allowing the virtual gateway of the first divided area to be in the closed status after the self-propelled device leaves the first divided area;
searching for, according to the virtual gateway control information, a second divided area that meets the predetermined condition from the currently enterable divided areas excluding the first divided area;
allowing the self-propelled device to enter the second divided area and allowing the virtual gateway of the second divided area to be in the closed status, so that the self-propelled device moves throughout the second divided area; and
obtaining a pattern of the second divided area and updating the map data after the self-propelled device moves throughout the second divided area.

5. The self-propelled device according to claim 1, wherein the predetermined condition includes:
among multiple paths between the self-propelled device and the currently enterable divided areas, a path between the self-propelled device and the first divided area is the shortest; or
among multiple paths between the self-propelled device and the virtual gateways of the currently enterable divided areas, a path between the self-propelled device and the virtual gateway of the first divided area is the shortest.

6. The self-propelled device according to claim 1, wherein the step of obtaining the map data includes:
generating the map data based on the information of the self-propelled device moving on the surface, in which the map data include the divided areas, and the divided areas correspond to multiple areas of the surface, respectively; and
arranging the virtual gateways on the divided areas, respectively.

7. The self-propelled device according to claim 6, wherein the virtual gateway control information is formed by a user selecting at least a part of a plurality of divided area images of the divided areas of the map data displayed on the remote device.

8. The self-propelled device according to claim 7, wherein each of the at least a part of the divided area images further includes a virtual gateway image, and the virtual gateway control information is formed by the user selecting at least a part of the virtual gateway images displayed on the remote device.

9. The self-propelled device according to claim 7, wherein
the cleaning information further includes a cleaning mode of at least one of the divided areas, and
the cleaning mode is formed by selecting cleaning mode options of the at least one of the divided areas from a setting window displayed, on the remote device, after the user selects the divided area images of the map data displayed on the remote device.

10. The self-propelled device according to claim 2, wherein the predetermined condition includes:
among multiple paths between the self-propelled device and the currently enterable divided areas, a path between the self-propelled device and the first divided area is the shortest; or
among multiple paths between the self-propelled device and the virtual gateways of the currently enterable divided areas, a path between the self-propelled device and the virtual gateway of the first divided area is the shortest.

11. A method for controlling a self-propelled device, wherein the self-propelled device comprises a moving means for moving the self-propelled device on a surface; a sensing module for sensing information of the self-propelled device moving on the surface; and a control module electrically connected to the sensing module and the self-propelled device,
wherein the method comprises:
obtaining map data including a plurality of virtual gateways, in which each of the virtual gateways corresponds to a divided area and includes an open status or a closed status, wherein the open status is configured to allow the self-propelled device to pass through, and the closed status is configured to prevent the self-propelled device from passing through;
receiving cleaning information from a remote device, in which the cleaning information includes virtual gateway control information, and the virtual gateway control information includes information that the virtual gateways are in the open status or the closed status;
searching for a first divided area, which meets a predetermined condition, from currently enterable divided areas according to the virtual gateway control information; and
allowing the self-propelled device to enter the first divided area and move throughout the first divided area.

12. The method for controlling a self-propelled device according to claim 11, wherein the step of moving throughout the first divided area further includes:
allowing the virtual gateway of the first divided area to be in the closed status after the self-propelled device enters the first divided area; and
obtaining a pattern of the first divided area and updating the map data after the self-propelled device moves throughout the first divided area, and
the method further includes:
allowing the virtual gateway of the first divided area to be in the open status after the self-propelled device moves throughout the first divided area, and allowing the virtual gateway of the first divided area to be in the closed status after the self-propelled device leaves the first divided area;
searching for, according to the virtual gateway control information, a second divided area that meets the predetermined condition from the currently enterable divided areas excluding the first divided area;
allowing the self-propelled device to enter the second divided area and allowing the virtual gateway of the second divided area to be in the closed status, so that the self-propelled device moves throughout the second divided area; and
obtaining a pattern of the second divided area and updating the map data after the self-propelled device moves throughout the second divided area.

13. The method for controlling a self-propelled device according to claim 11, wherein the predetermined condition includes:
among multiple paths between the self-propelled device and the currently enterable divided areas, a path between the self-propelled device and the first divided area is the shortest; or
among multiple paths between the self-propelled device and the virtual gateways of the currently enterable divided areas, a path between the self-propelled device and the virtual gateway of the first divided area is the shortest.

14. The method for controlling a self-propelled device according to claim 11, wherein the step of obtaining the map data includes:
generating the map data based on the information of the self-propelled device moving on the surface, in which the map data include the divided areas, and the divided areas correspond to multiple areas of the surface, respectively; and
arranging the virtual gateways on the divided areas, respectively.

15. The method for controlling a self-propelled device according to claim 11, before receiving the cleaning information from the remote device, further comprising:
generating the cleaning information by using the remote device.

16. The method for controlling a self-propelled device according to claim 15, wherein the step of generating the cleaning information by using the remote device includes:
showing, by the remote device, a plurality of divided area images of the divided areas of the map data; and
generating the virtual gateway control information according to a signal of at least a part of the divided area images displayed on the remote device and selected by a user.

17. The method for controlling a self-propelled device according to claim 16, wherein each of the at least a part of the divided area images further includes a virtual gateway image, and the virtual gateway control information is formed by the user selecting at least a part of the virtual gateway images displayed on the remote device.

18. The method for controlling a self-propelled device according to claim 16, wherein
the cleaning information further includes a cleaning mode of at least one of the divided areas, and
the cleaning mode is formed by selecting cleaning mode options of the at least one of the divided areas from a setting window displayed, on the remote device, after the user selects the divided area images of the map data displayed on the remote device.

19. The method for controlling a self-propelled device according to claim 15, wherein the step of generating the cleaning information by using the remote device includes:
showing, by the remote device, a plurality of divided area images of the divided areas of the map data;
generating the virtual gateway control information according to a signal of at least a part of the divided area images displayed on the remote device and selected by a user; and
after the user selects the divided area images displayed on the remote device, showing a setting window by the remote device, and generating the cleaning information according to the cleaning mode of the divided areas selected by the user.

20. The method for controlling a self-propelled device according to claim 12, wherein the predetermined condition includes:
among multiple paths between the self-propelled device and the currently enterable divided areas, a path between the self-propelled device and the first divided area is the shortest; or
among multiple paths between the self-propelled device and the virtual gateways of the currently enterable divided areas, a path between the self-propelled device and the virtual gateway of the first divided area is the shortest.
